(19) United States
(12) Patent Application Publication
(10) Pub. No.: US 2006/0210952 A1
(43) Pub. Date: Sep. 21, 2006

(54) Color identification system

(76) Inventor: Alix T. Toland, Jamestown, RI (US)

Correspondence Address: Cari & Offenberg;Attorneys at Law, 494 Broadway, Newport, RI, 02840, US

(21) Appl. No.: 10/730,906

(22) Filed: Oct. 30, 2002

(51) Int. Cl. G09B 19/00

(52) U.S. Cl. 434/106

(57) ABSTRACT

The present invention is a concentric color identification system allowing an individual to see his/her uniqueness in relation to others. The system is based on astrological signs with a color code and on the specific birth information of an individual.

### BACKGROUND OF THE INVENTION

1. Field of the Invention

The invention relates to a color-coded chart for zodiac signs. Specifically, to a chart including a concentric structure that includes a central moon circle, a concentric sun circle or ring and an outer concentric ascendant ring.

2. Description of Related Art

No prior art references exist disclosing or showing the subject invention. References that use the zodiac signs, the moon and sun and ascendant, and color do exist but not for the same purpose or in the same way as the present invention. Boyd, U.S. Pat. No. 4,379,698 discloses an astrology chart and coloring the twelve houses of astrology.

Quigley is an astrological comparison device including an assembly pair of rotatably interconnected wheels.

Lynch is an astrological comparison apparatus having wheels and movable indicators that contain data for simple and rapid comparison of the astrological criteria of individuals.

### BRIEF SUMMARY OF THE INVENTION

Twelve specific colors have been assigned by the inventor to the twelve astrological signs as follows:

| | | |
|---|---|---|
| 1. | Aires | Red |
| 2. | Taurus | Light Green |
| 3. | Gemini | Bright Blue |
| 4. | Cancer | Silver |
| 5. | Leo | Yellow |
| 6. | Virgo | Dark Green |
| 7. | Libra | Light blue |
| 8. | Scorpio | Black |
| 9. | Sagittarius | Orange |
| 10. | Capricorn | Brown |
| 11. | Aquarius | Dark Blue |
| 12. | Pieces | Lavender |

These color choices are in keeping with the elemental alignments, qualities and planetary rulerships of each sign. Using an astrological background, the inventor has designed a color identification system. The Zodiac is a circle of space in the sky containing the orbits of the planets. The Zodiac circle is divided into twelve parts. These divisions are known as the signs of the Zodiac.

The revolution of the earth around the sun complete in one year causes the sun to appear to travel through the Zodiac at a rate of approximately one sign per month. The moon is seen as moving through one sign within days. Due to the earth's rotation on its axis, making a complete turn every twenty hours, a new sign appears on the eastern horizon every two hours. It is called the ascendant.

An individual will have the sun, the moon and the ascendant in certain astrological signs based on time, date and geographical place of birth. The time and place of birth is translated in a color system. In this invention, the sun, moon and ascendant are represented in a three part concentric form in keeping with their esoteric nature. At the time of birth, the astrological sign of the sun is given the color from the chart and place in the middle ring of the circle. At the time of birth, the astrological sign of the moon is given the color from the chart and placed in the inner most circle. At the time of birth, the astrological sign of the ascendant is given the color from the chart and place is the outer most circle. Thus, resulting in a unique system for identifying an individual by color. By assigning appropriate color to this concentric form an individual obtains his or her own color identification. There are 1,728 possible color combinations. It is conceivable to use additional planetary information to extend the concentric circles or to use a planet in place of an ascendant.

The sun is said to represent the personality or vital life force. The moon is aligned to the emotional or interior realm. The sign on the ascendant describes an immediate or surface impression. This concentric color identification system allows an individual to see his/her uniqueness in relation to others, and further, groups of individuals can see their interconnectedness. Comparisons and similarities are readily apparent through color. Thousands of note worthy people have been color coded thus far, making it easy for an individual to find which people throughout history have the same elemental makeup, the same color identification as their own.

There are multiple applications for this invention. Games, stickers, cards, color changing clocks, wrapping paper, computer screed savers randomly display color coded artists, inventors, musicians, world leaders, writers,—anyone noteworthy with documented birth data. The system is used for identification of an individual and comparison to others but the resulting concentric forms may be used in a variety of ways.

The present invention gives the user a simple means of readily identifying their birth information and comparing such information to other individuals, either personal friends, family members or other noteworthy individuals, to determine similarities and differences. The colors of the concentric forms allows for one to look at their color coded form and easily identify if the they are the same or different from other individuals. Also, it is a way to see how you look from an elemental point of view.

### BREIF DESCRIPTION OF THE DRAWING

FIG. 1 is a sample of one concentric color form showing the relationship of the sun, moon and ascendant.

FIG. 2 is a list of the colors assigned to the astrological signs FIG. 3 is a chart of the 1728 possible combinations of concentric color forms in color code with numerical identification

### DETAILED DESCRIPTION OF THE PREFERRED EMBODIMENT

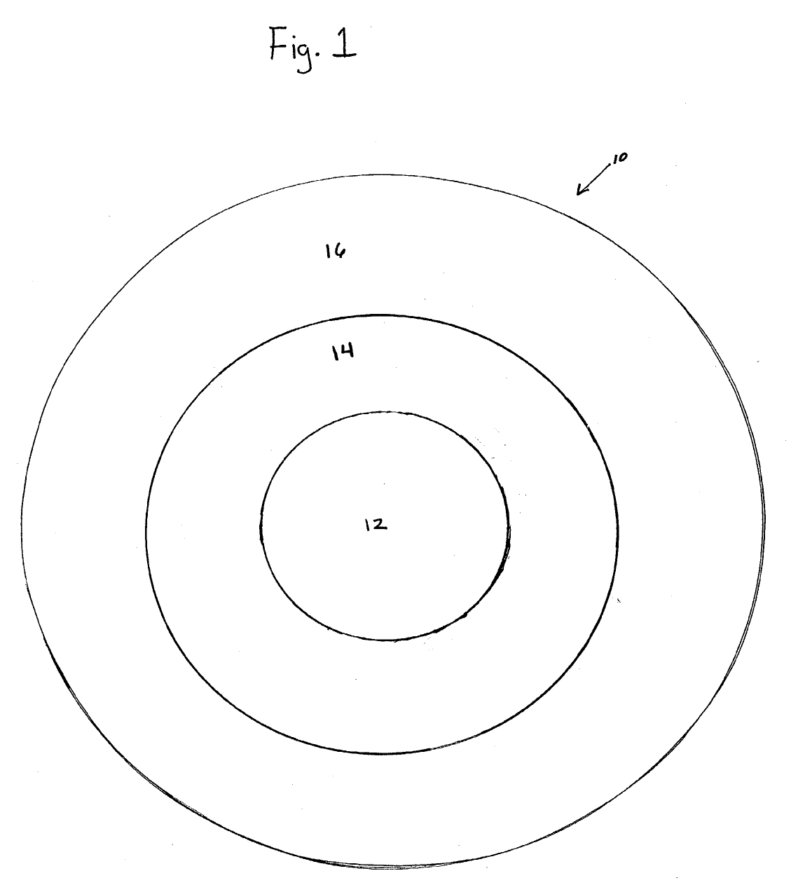

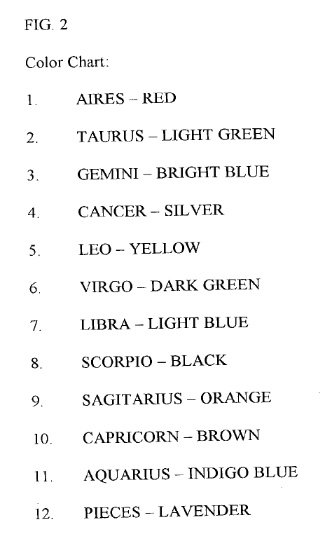

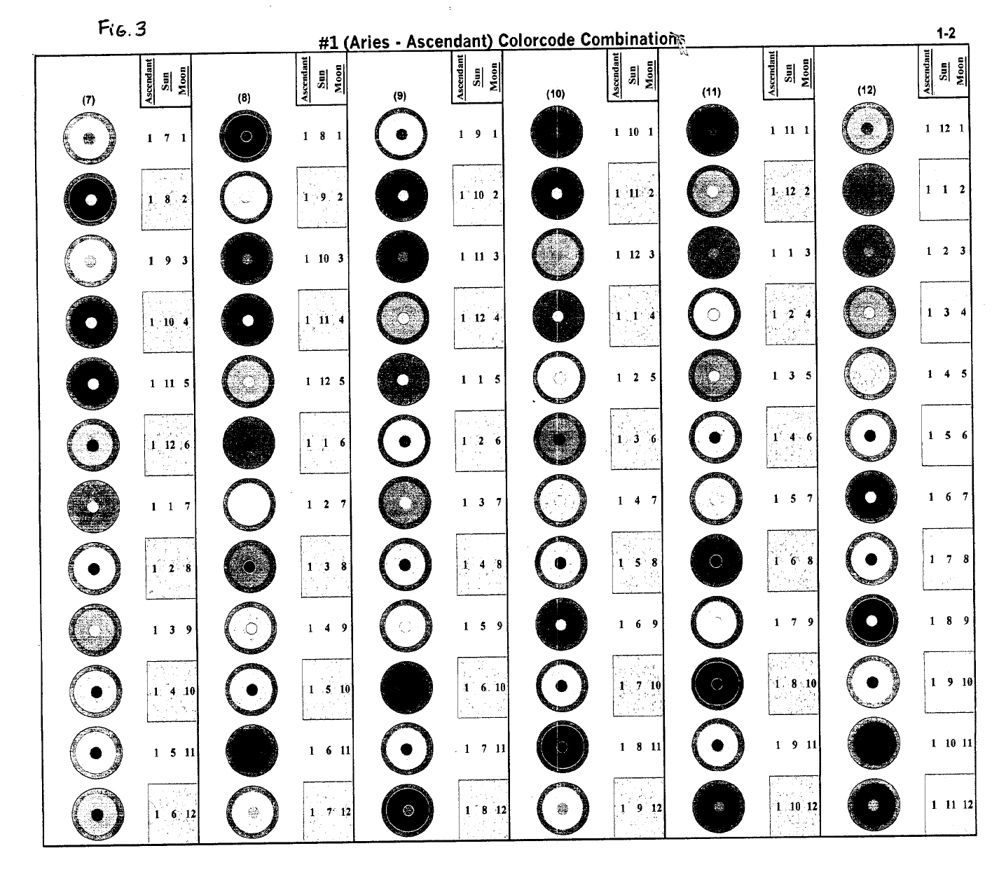

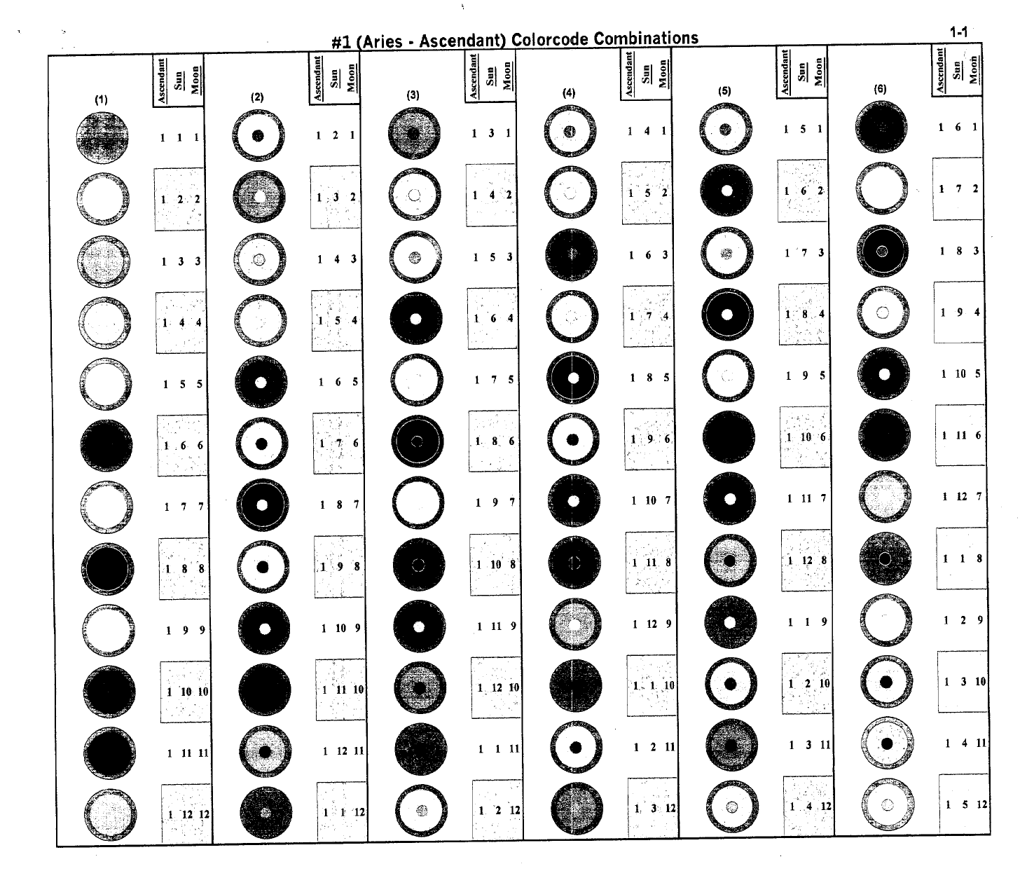

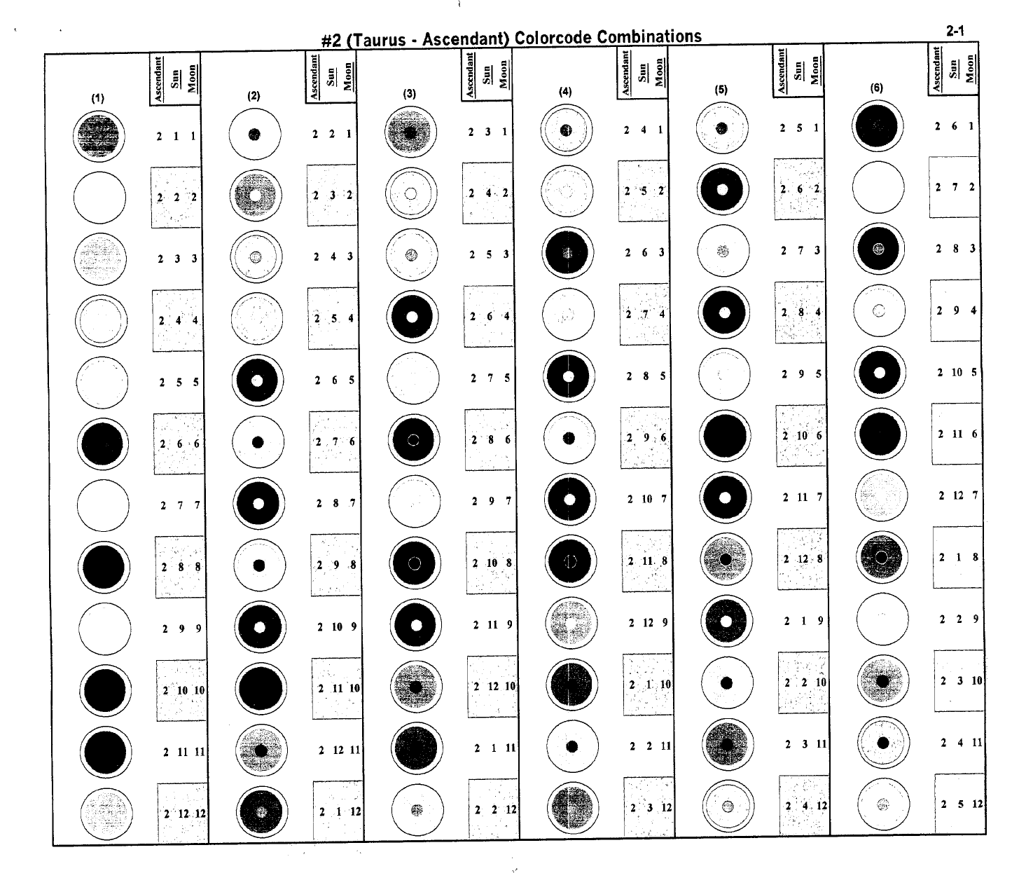

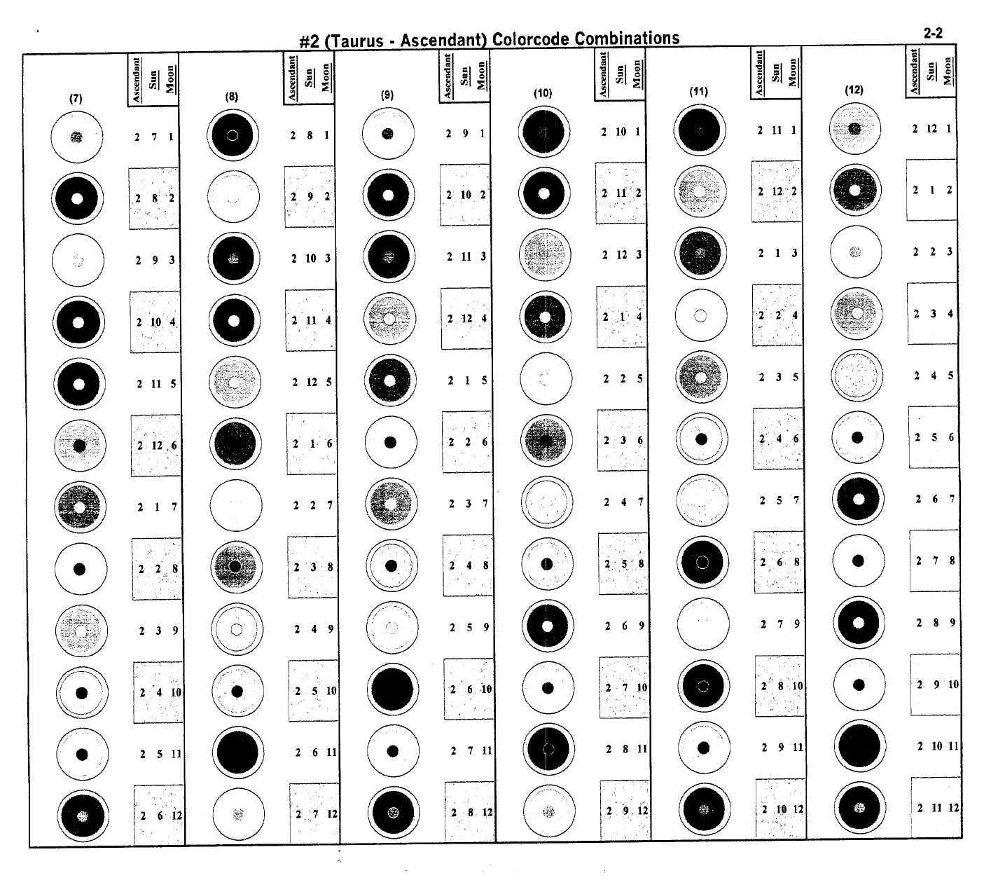

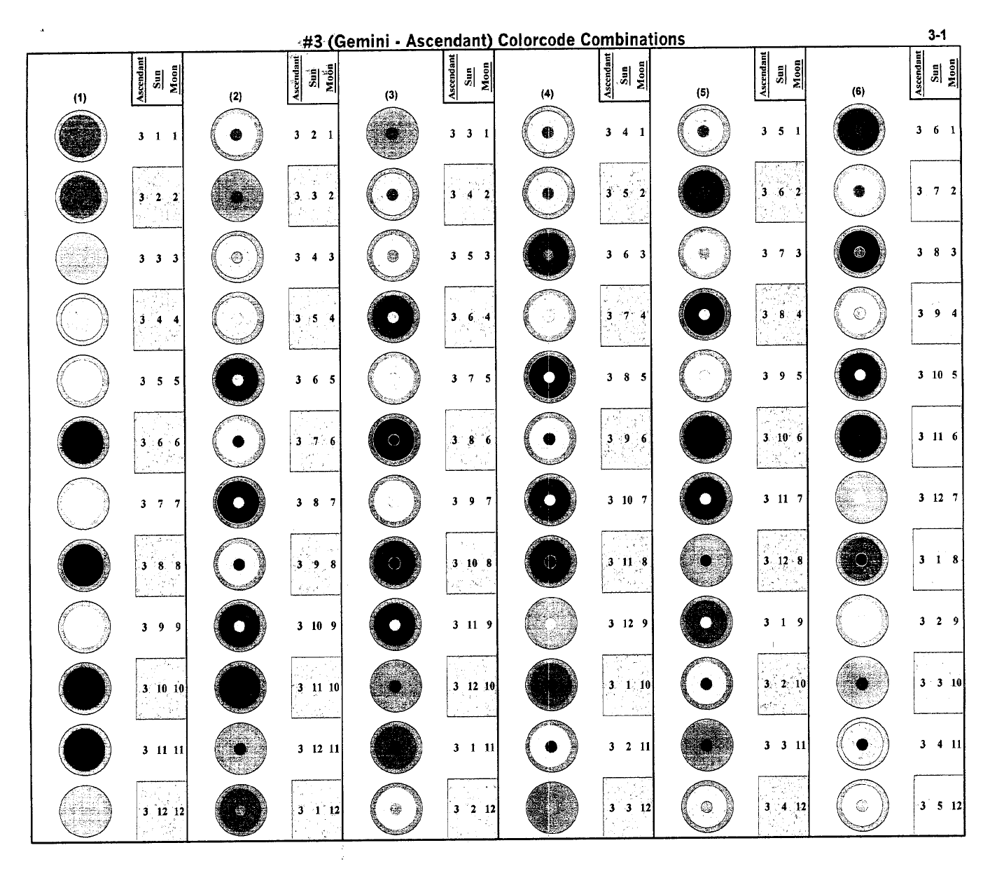

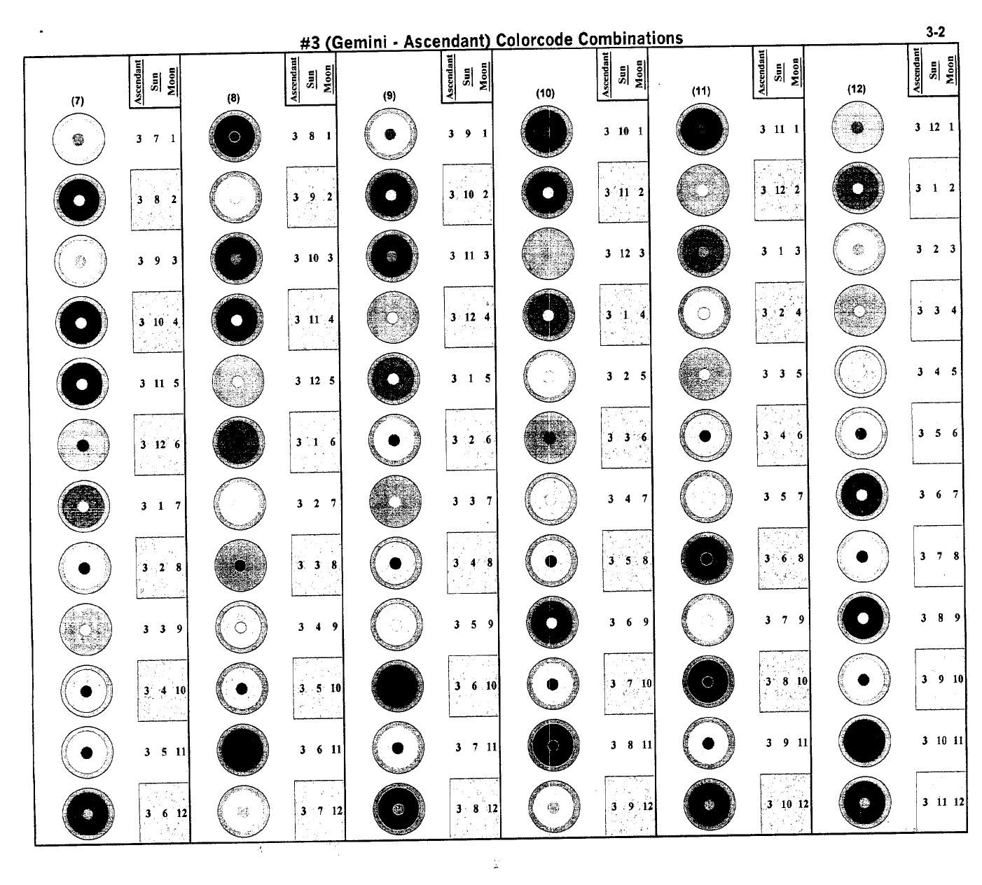

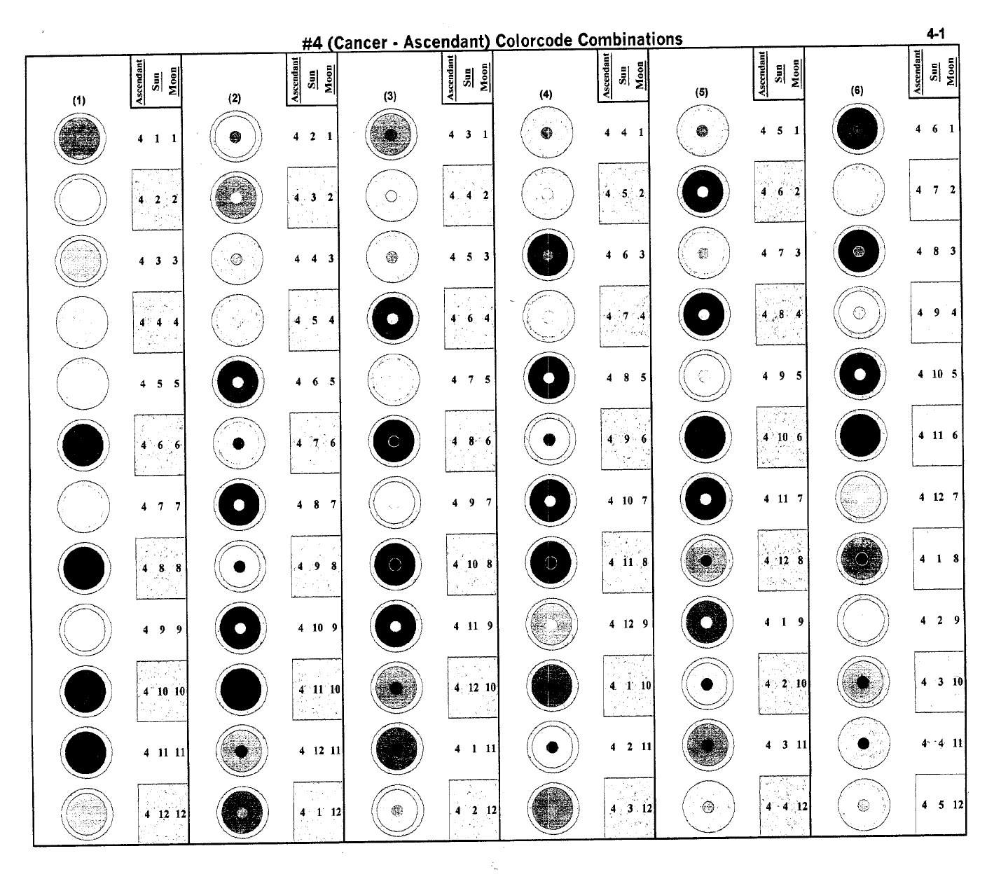

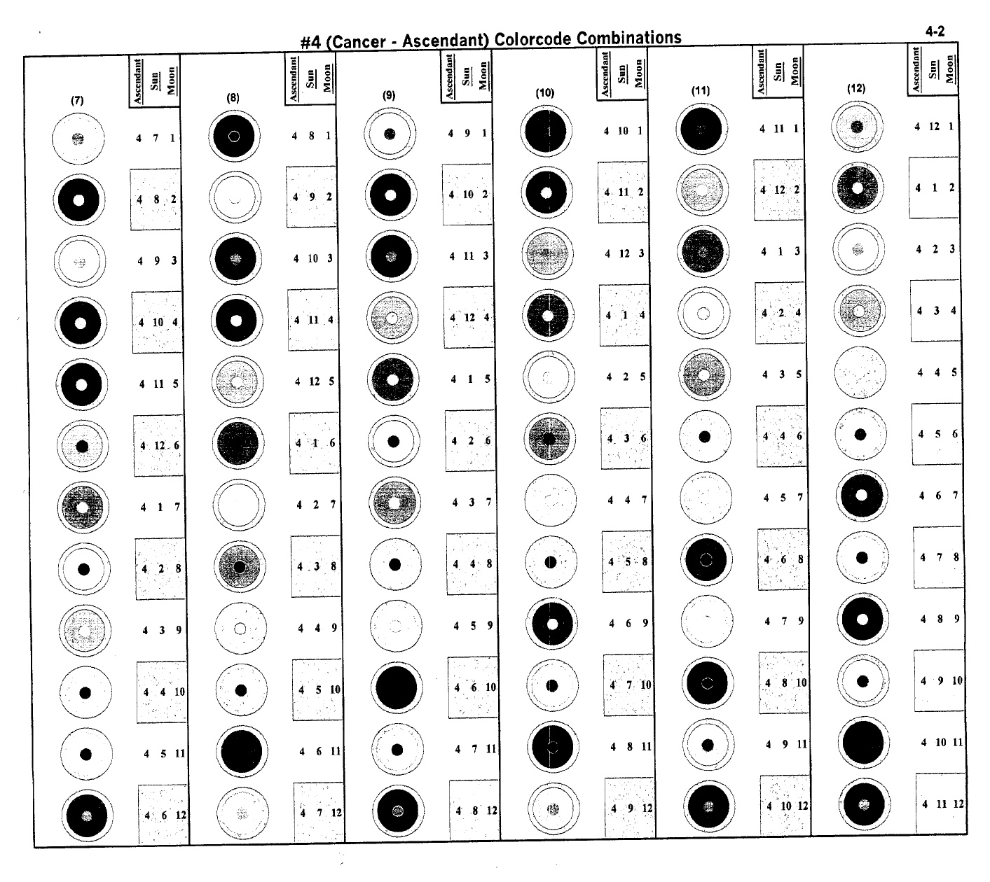

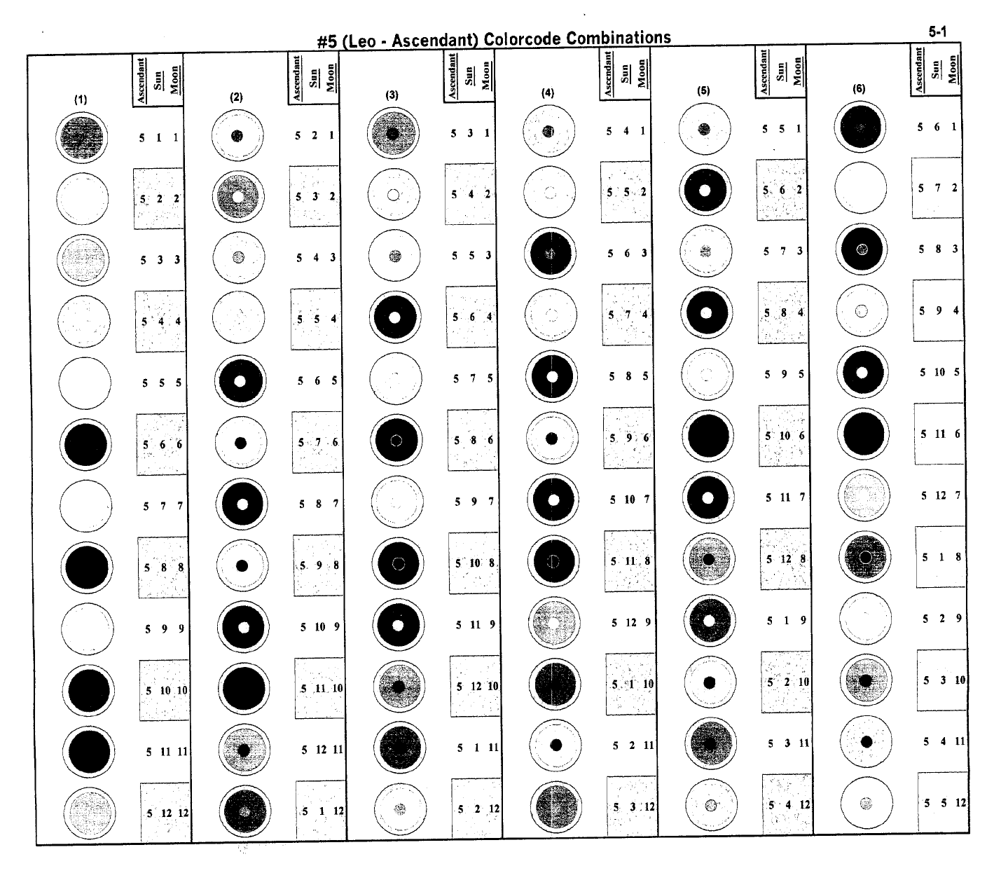

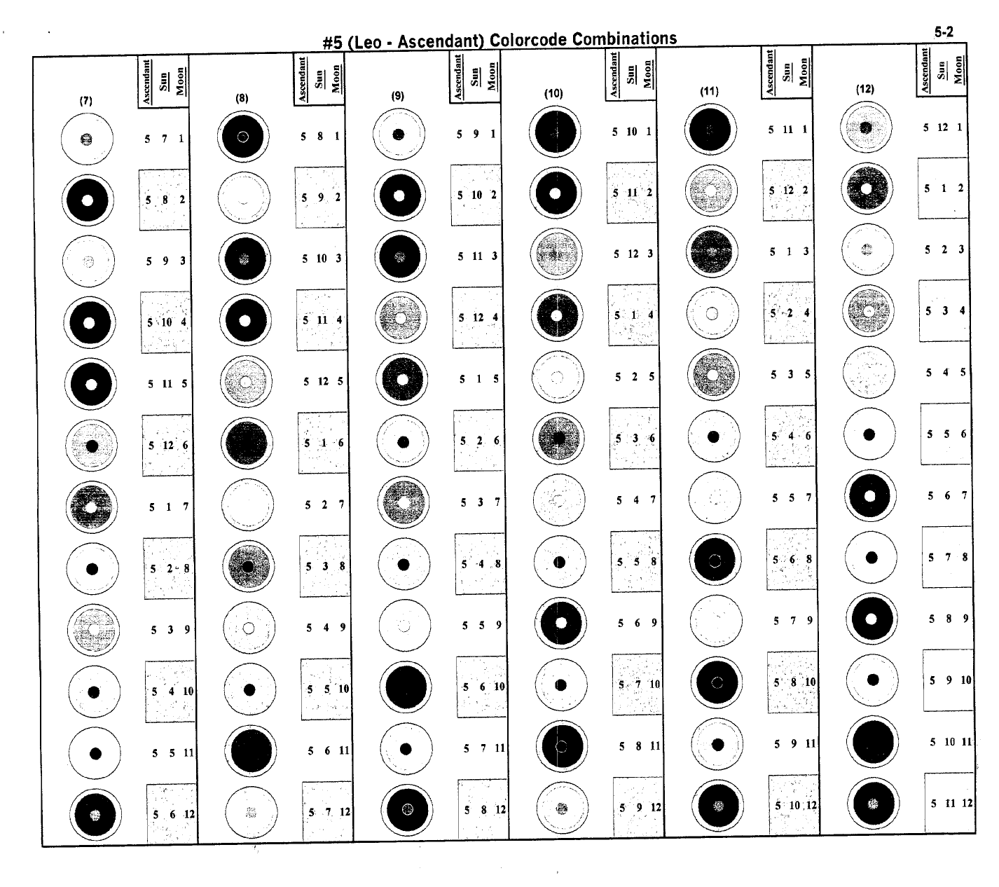

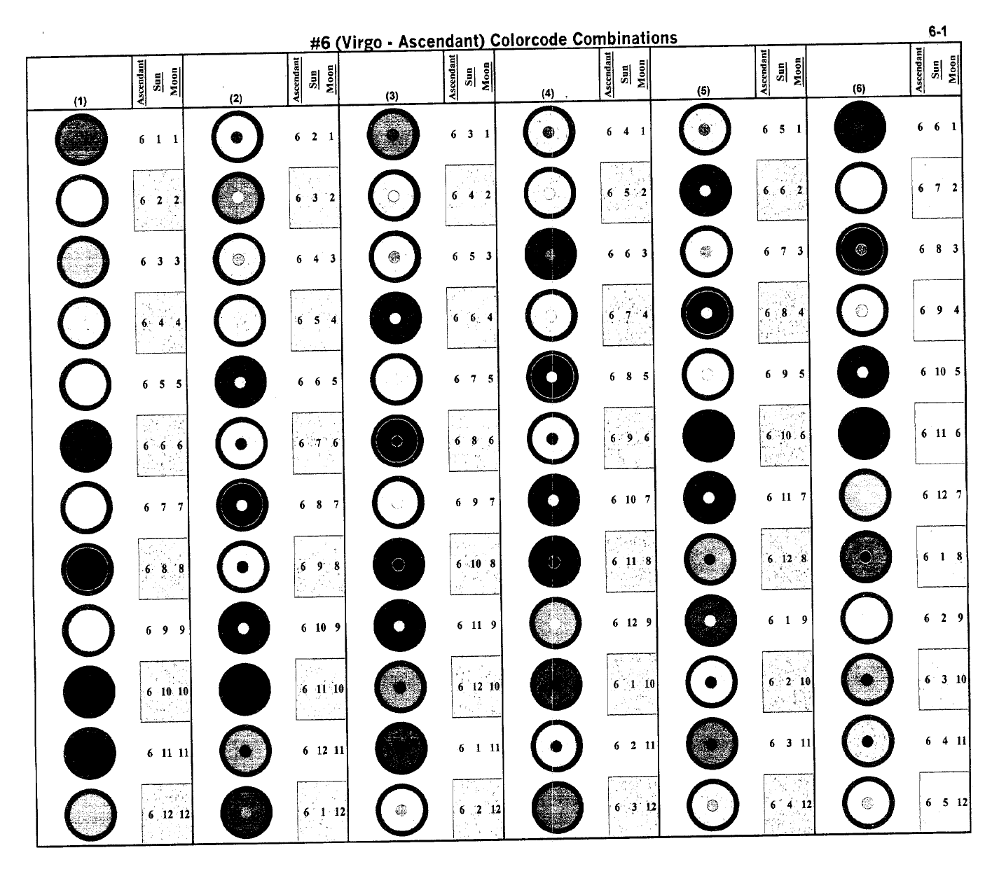

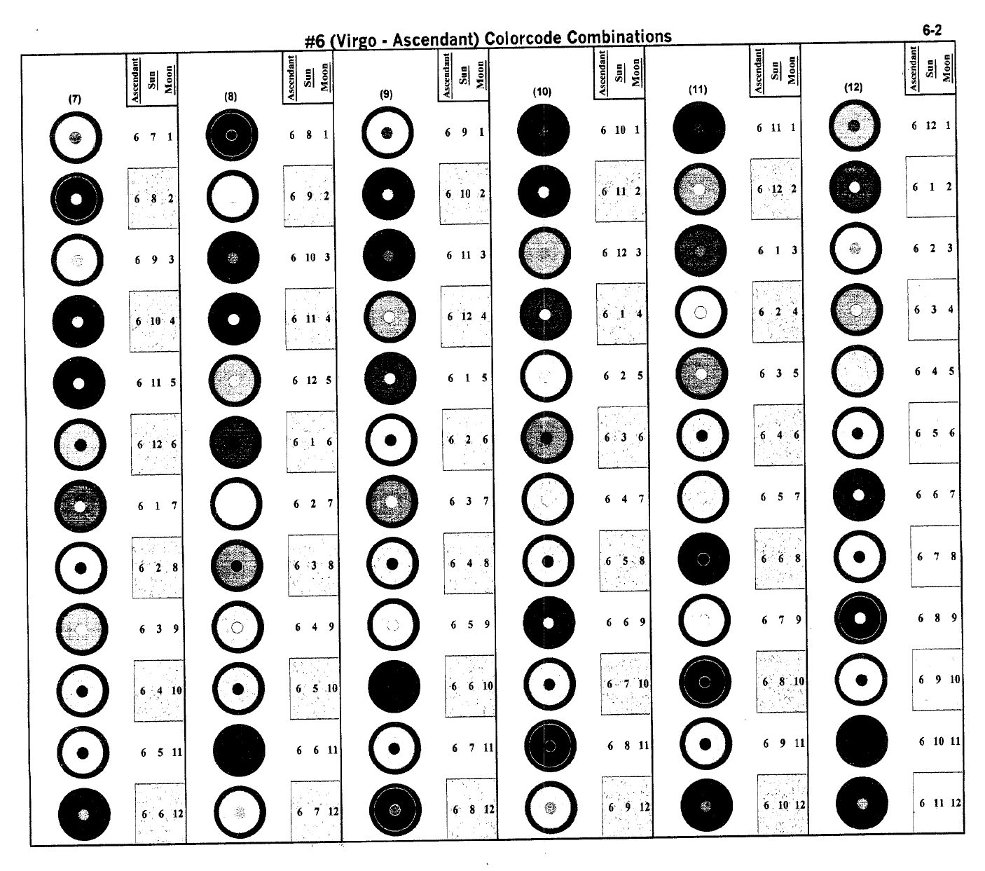

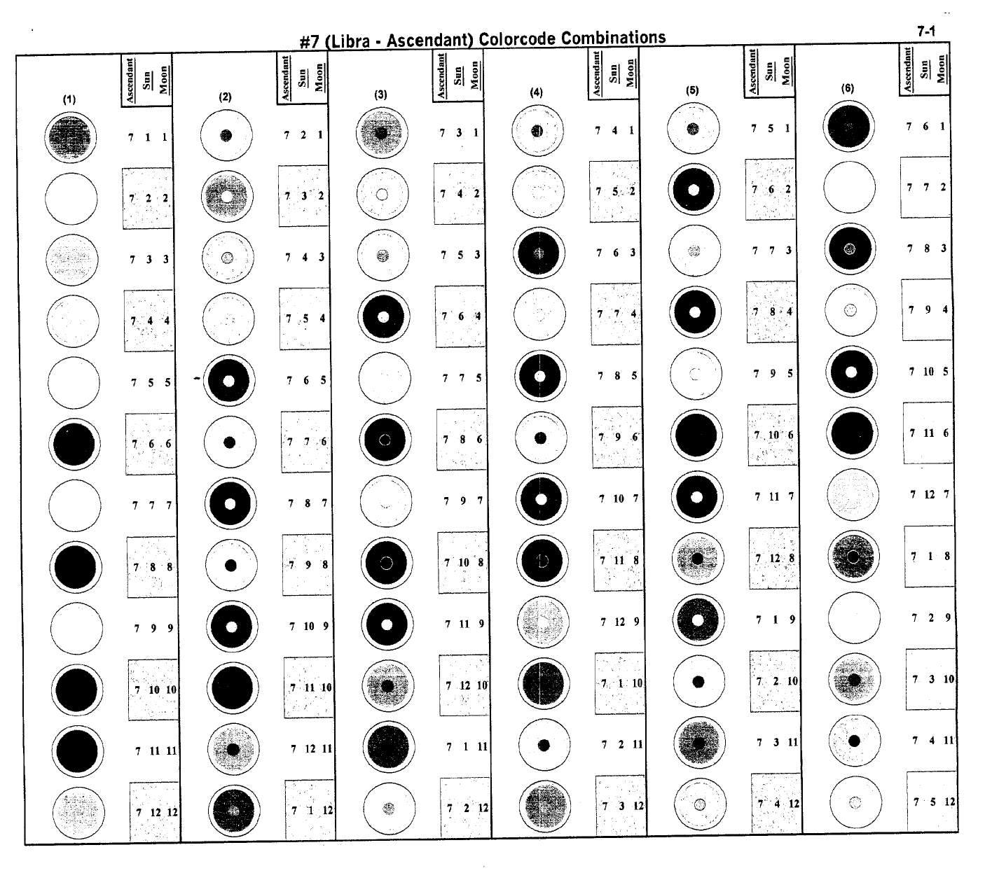

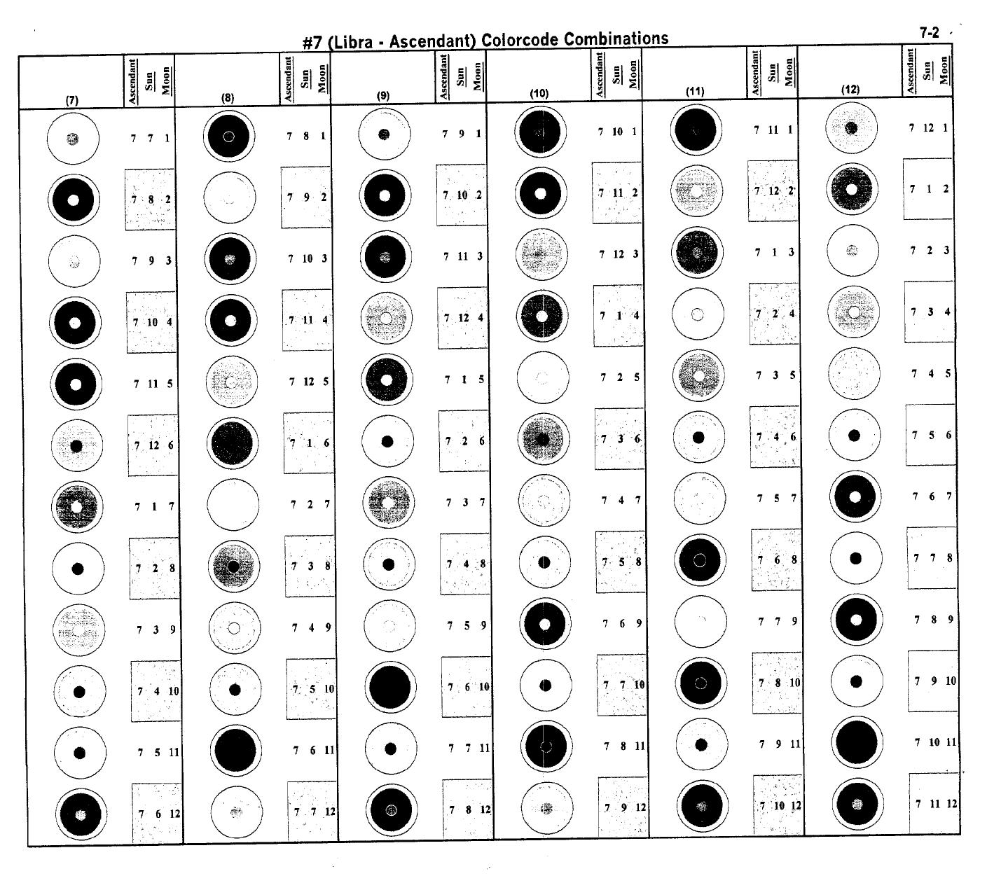

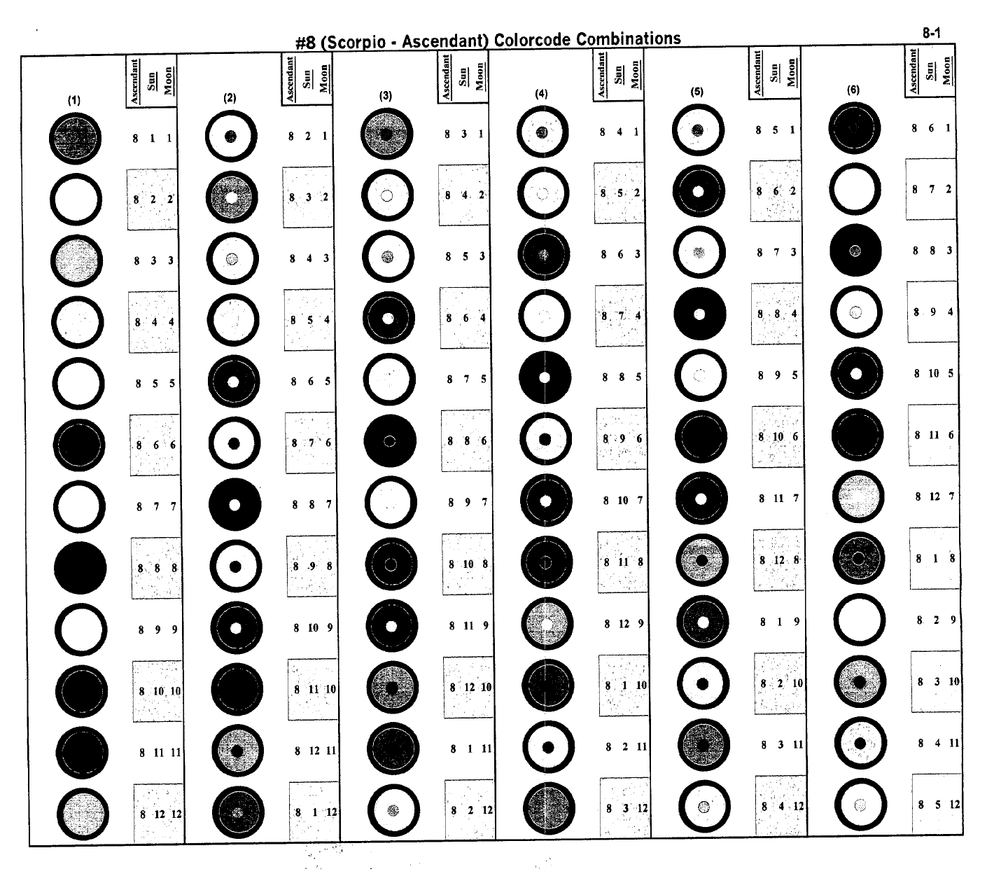

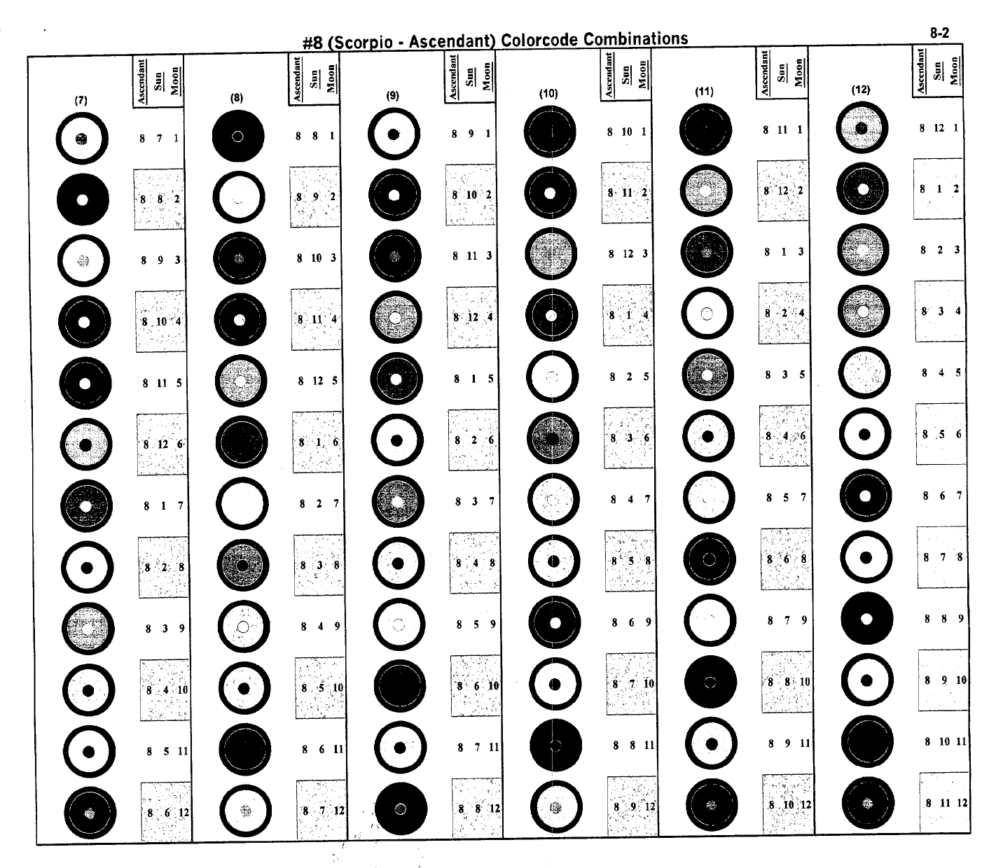

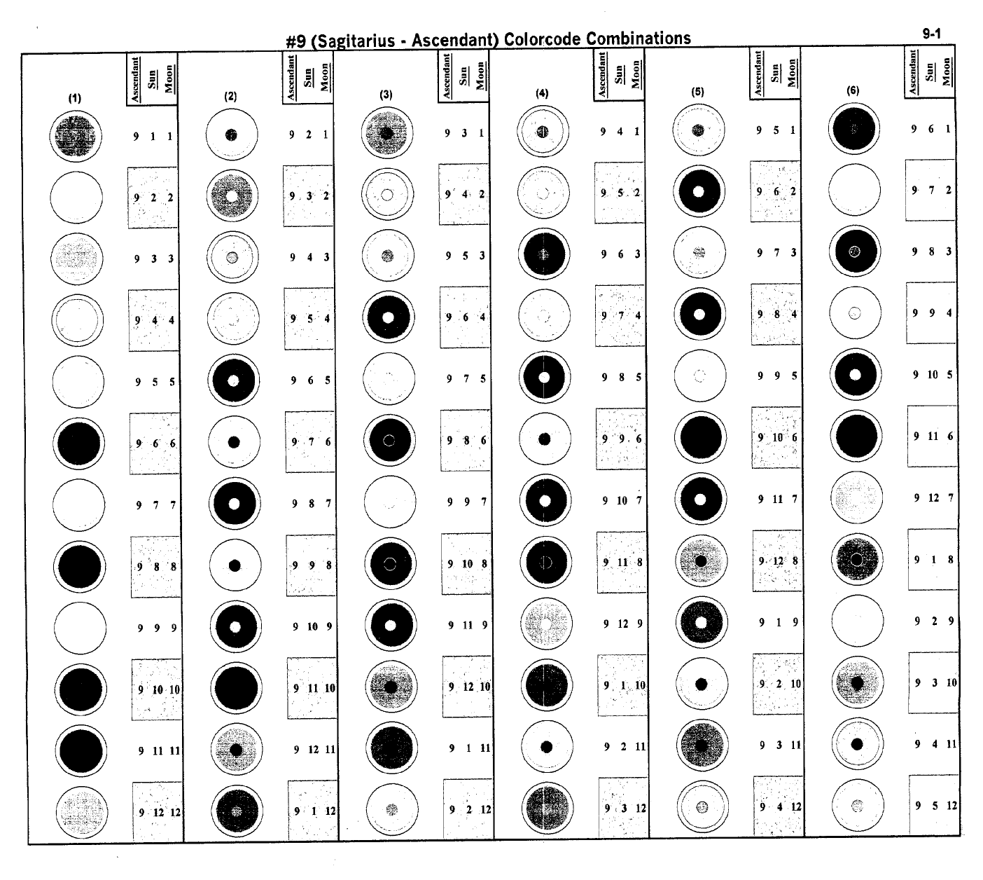

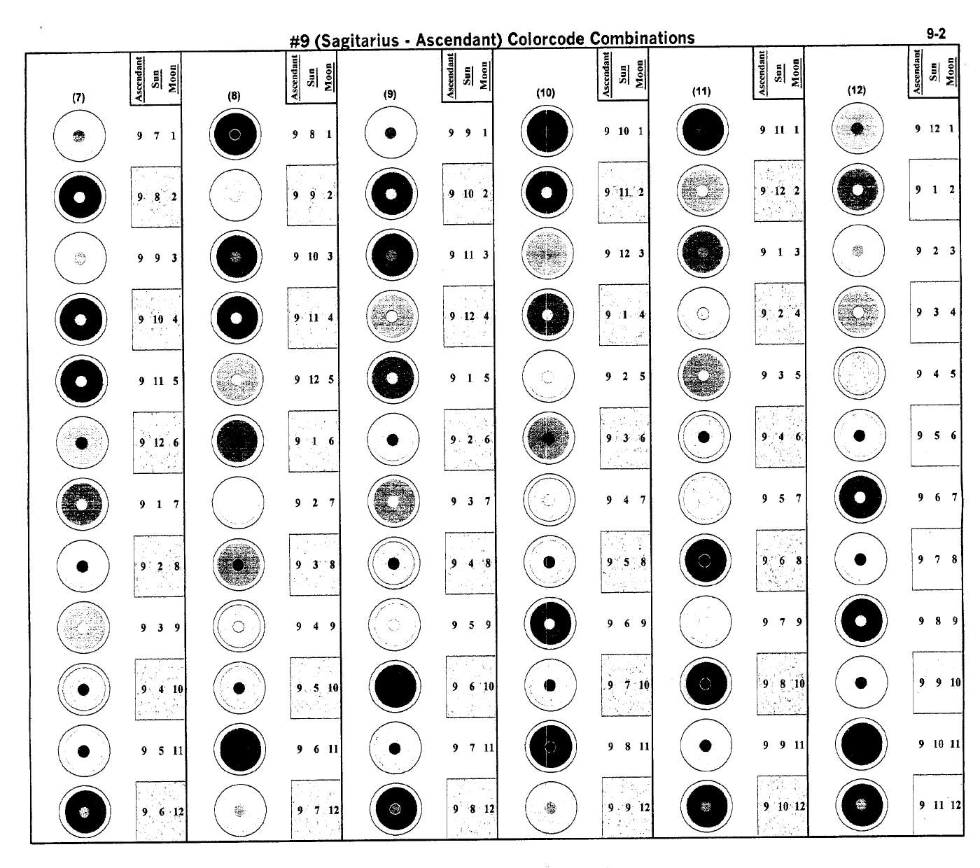

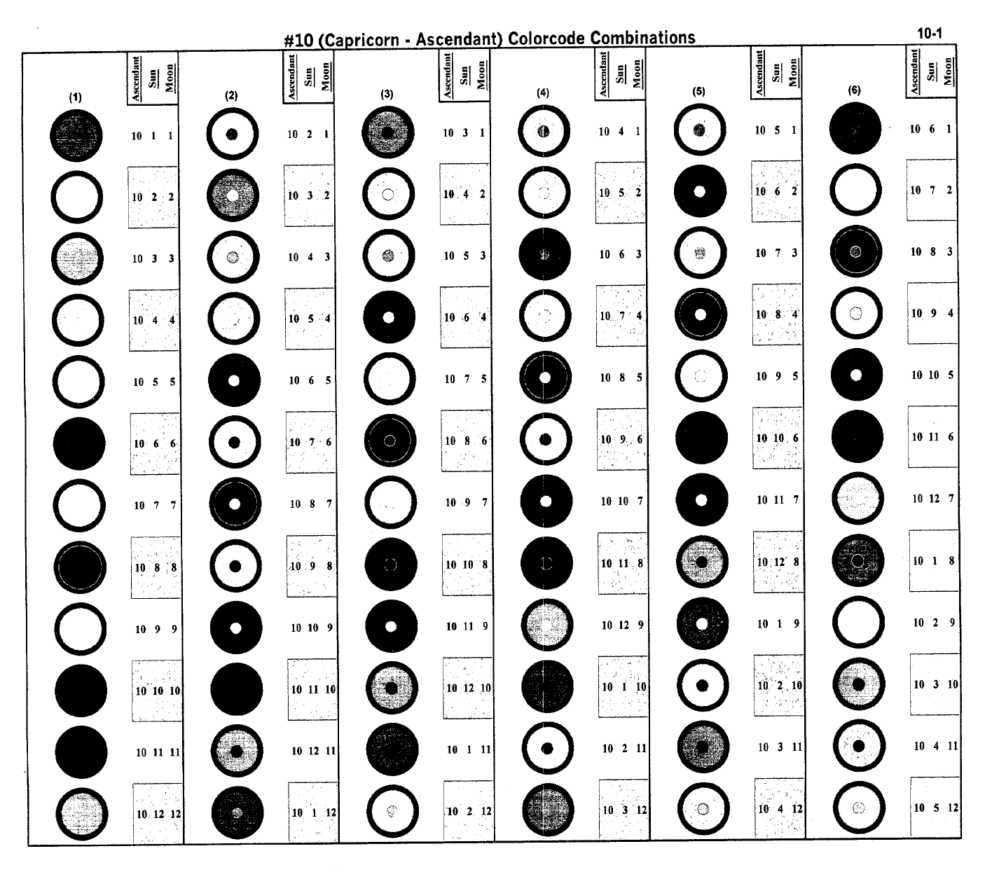

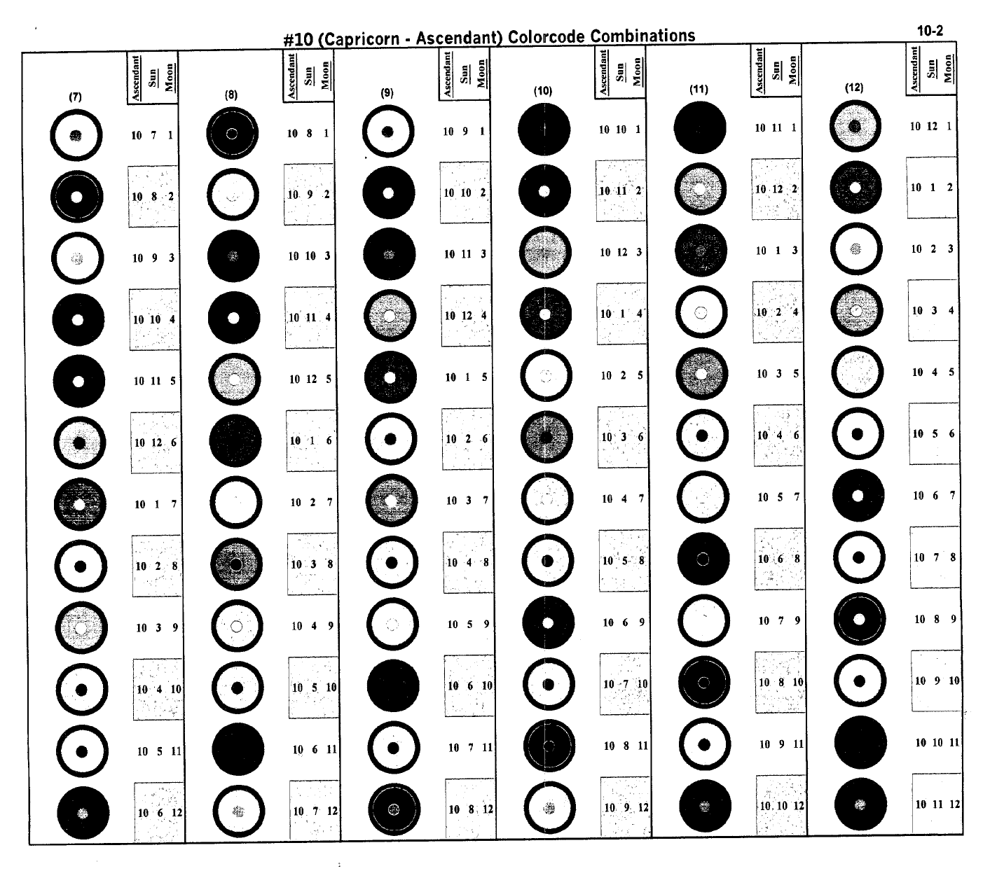

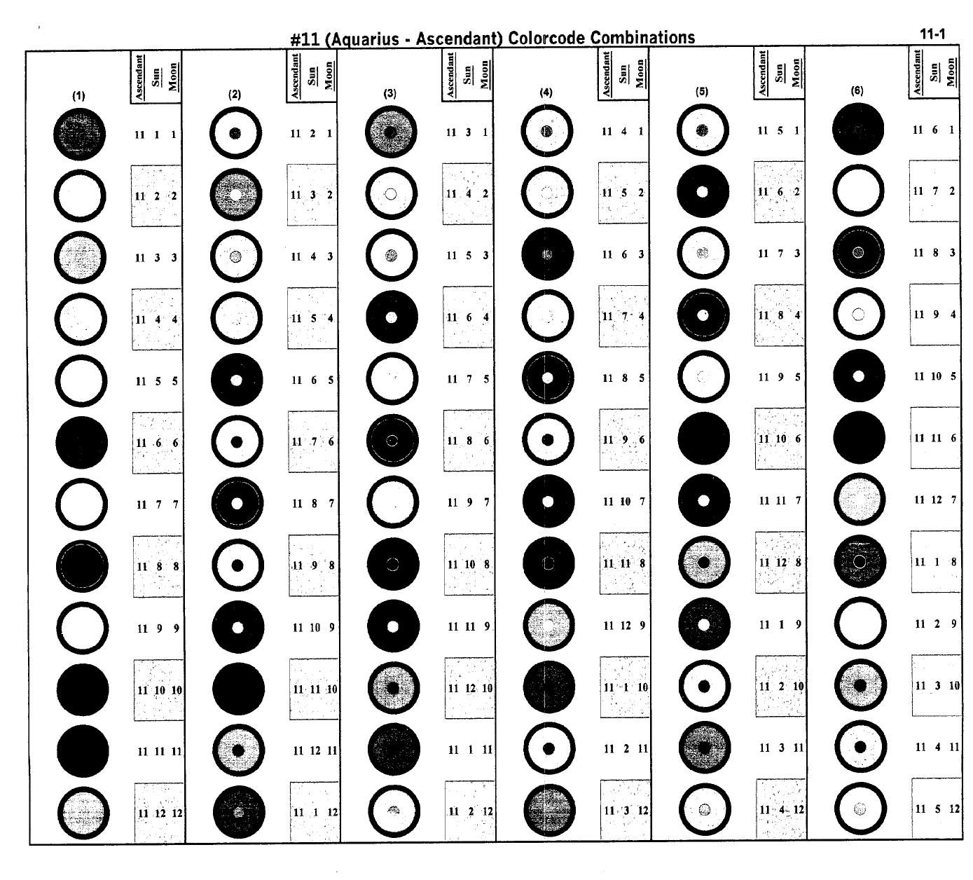

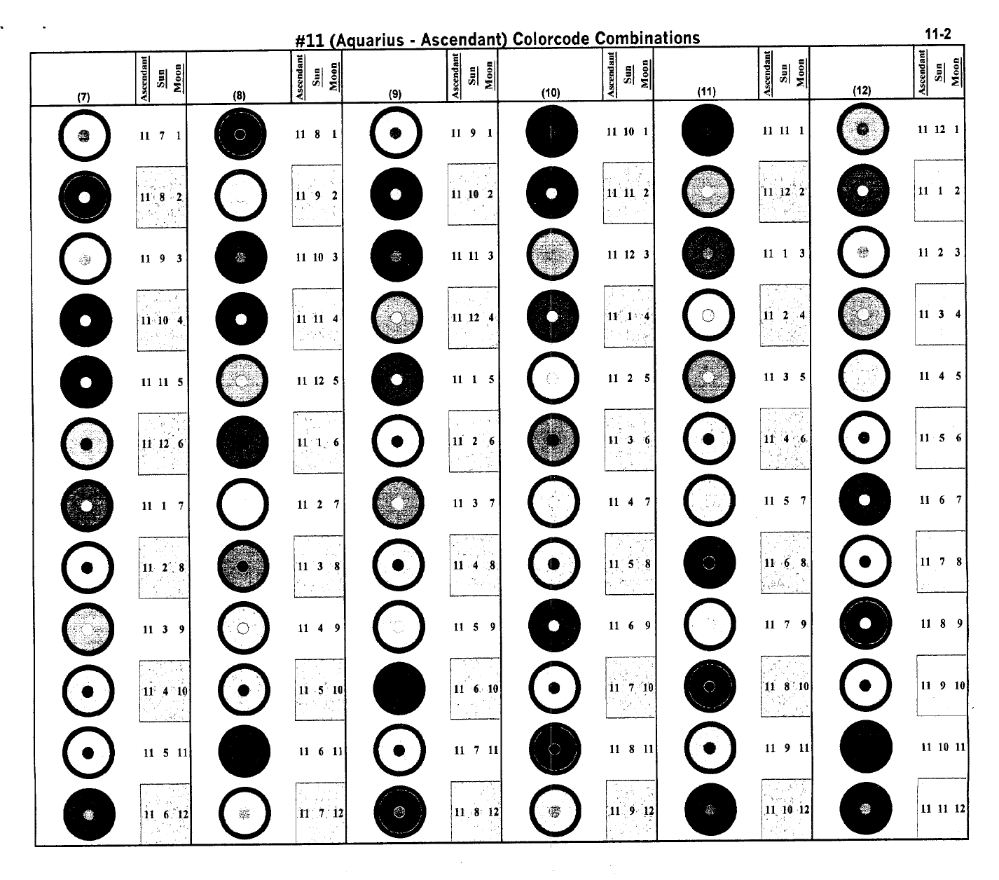

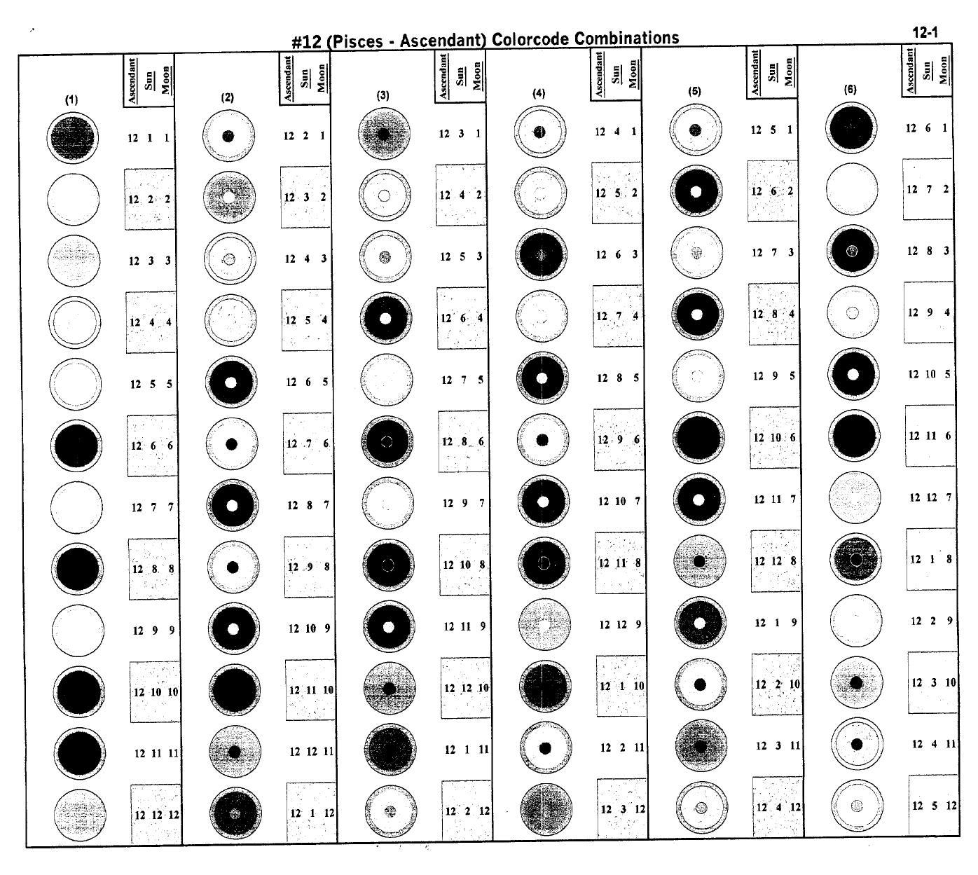

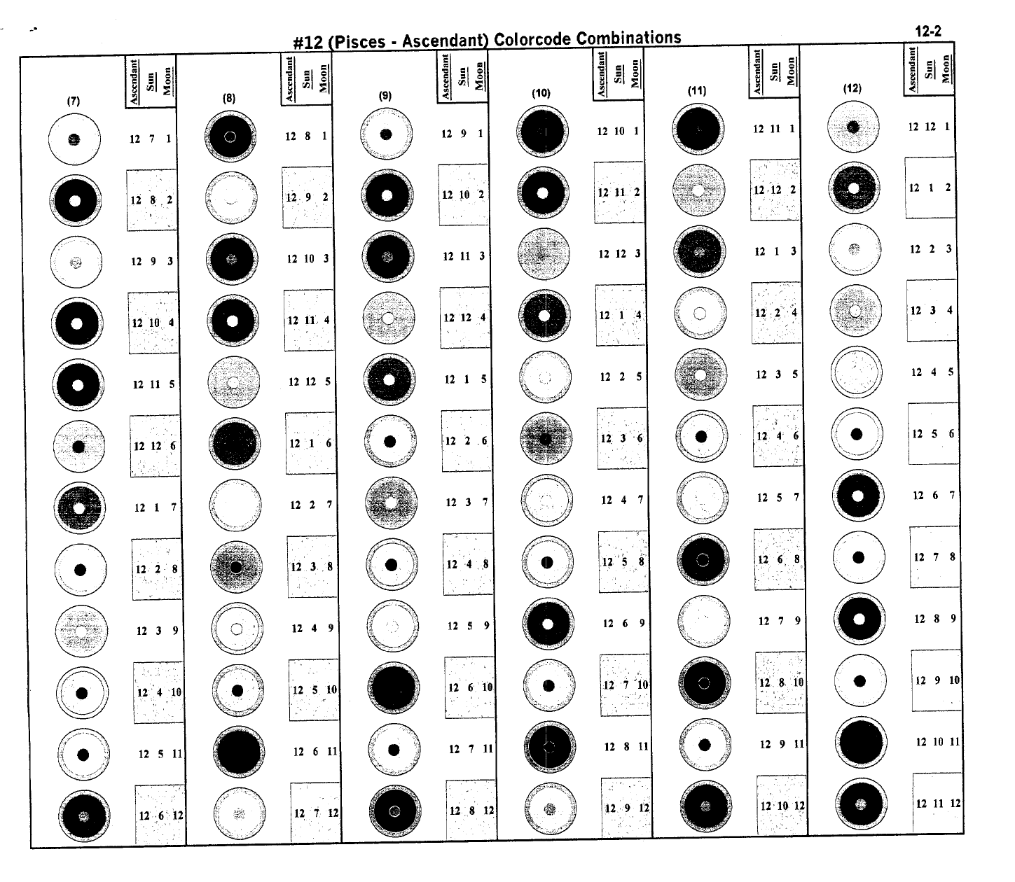

The present invention consists of a color-coded chart for identification of an individual's personal characteristics based on the location of the moon, sun and ascendant at birth of the individual. As shown in FIG. 1, the system includes a three part concentric form (10) that includes a first concentric circle (12) representing the moon, a second concentric circle (14) representing the sun; and a third concentric circle (16), representing the ascendant. The first concentric circle is the inner one; the second concentric circle is the center circle, and the third concentric circle is the outer circle. The three concentric circles/rings are assigned appropriate elemental colors according to the twelve astrological signs as illustrated in FIG. 2. A color chart shown in FIG. 2 is created that assigns twelve colors corresponding to the twelve astrological signs. A user must know the time, date, and place of their birth in order to determine the location of the sun, moon and ascendant from an astrological ephemeris.

The simple geometric forms are color coded to give personal information through birth data of individual. The user can determine their form using the color coded chart and placing the color in the appropriate concentric circle/ring. The resulting color form translates information regarding elemental characteristics of that color form. The user can then see their elemental characteristics in color and compare to others with similar or exactly identical color forms. The user can also compare their form to other well-known persons and know with whom they identify or to whom they are similar or dissimilar.

As there are 12 astrological signs and 12 colors and three different parameters that are being colored there is a fixed number (1728) of different color forms as shown in FIG. 3. There are 1728 possible codes to come from this method therefore every individual will be the same as someone. With the accurate birth information of an individual, a color form can be created for any individual. Therefore, by using directories and/or printed volumes of birth information, the color form of a variety of persons could be mapped out for use as comparisons.

This method can be used for a number of purposes, such as for pure fun of learning who has personality traits similar to the user—like when comparing horoscopes or birth signs. For use in a game to determine what famous person's color codes are similar or dissimilar to each other. To determine personality traits based on the similar color forms. Or, for numerous other purposes, as the user so desires.

What is claimed is:

1. A color identification system of at least three concentric circles based on astrological signs comprising:
creating a color code chart for astrological signs
using birth data information to determine the astrological sign of the moon at the time and place of an individual's birth and assigning the moon sign a color from the color coded chart;
using birth data information to determine the astrological sign of the sun at the time and place of an individual's birth and assigning the sun sign a color from the color coded chart;
using birth data information to determine the astrological sign of the ascendant at the time and place of an individual's birth and assigning the ascendant a color from the color coded chart;
creating a color form of three concentric circles where the color from the moon is a first concentric circle; where the color from the sun is a second concentric circle; and where the color from the ascendant is a third most concentric circle.

2. A color identification system based on astrological signs as claimed in claim 1 wherein the first concentric circle is an inner circle, the second concentric circle is the center circle and the third concentric circle is an outer circle.

3. A color identification system based on astrological signs as claimed in claim 1 wherein the resulting color form is used for comparison to another color form.

4. A color identification system based on astrological signs as claimed in claim 1 wherein the color form or multiple color forms are used for trading cards.

5. A color identification system based on astrological signs as claimed in claim 1 wherein the system is used to play a game of determining color forms of many individuals.

6. A color identification system based on astrological signs as claimed in claim 1 wherein the color form or multiple color forms are made into stickers or button pins.

7. A color identification system based on astrological signs as claimed in claim 1 wherein the color form or multiple color forms are copied in a repeating pattern onto paper as wrapping paper.

8. A color identification system based on astrological signs as claimed in claim 1 wherein the color form or multiple color forms are used as computer screen savers.

9. A color identification system based on astrological signs as claimed in claim 1 further comprising using birth data information to determine the astrological sign of a planet at the place, time and date of birth in place of the ascendant information.

10. A color identification system based on astrological signs as claimed in claim 1 wherein four or more concentric circles are used to create the color form.

11. A color identification system based on astrological signs as claimed in claim 1 wherein the astrological signs are assigned the following colors:

| | |
|---|---|
| Aires | Red |
| Taurus | Light Green |
| Gemini | Bright Blue |
| Cancer | Silver |
| Leo | Yellow |
| Virgo | Dark Green |
| Libra | Light blue |
| Scorpio | Black |
| Sagittarius | Orange |
| Capricorn | Brown |
| Aquarius | Dark Blue |
| Pieces | Lavender |
